(19) United States
(12) Patent Application Publication
(10) Pub. No.: US 2008/0308133 A1
(43) Pub. Date: Dec. 18, 2008

(54) Method and apparatus for wet conveyor car wash and detail

(76) Inventors: William Lewis Grubb, Finksburg, MD (US); James Gerry Thomas, JR., Lutherville, MD (US); William J. Salladin, Cockeysville, MD (US)

Correspondence Address: Ober, Kaler, Grimes & Shriver;Attorneys at Law, 120 East Baltimore Street, Baltimore, MD, 21202-1643, US

(21) Appl. No.: 12/082,414

(22) Filed: Apr. 10, 2008

Related U.S. Application Data
(60) Provisional application No. 60/922,756, filed on Apr. 10, 2007.

(51) Int. Cl. B60S 3/04

(52) U.S. Cl. 134/72

(57) ABSTRACT

A hand wash cash wash system for motor vehicles based on a fully-wet belt conveyor through a plurality of stations including a manual hand-wash station. The conveyor is adapted for continuous operation in a wet environment and indeed relies on the water from the wash stations for lubrication. The adaptations for wet-belt design include a concrete foundation formed with a recessed drainage pit for runoff. A superstructure is seated atop the foundation and this comprises a framework of galvanized steel legs and struts. The continuous conveyor is mounted on the superstructure further comprises a conveyor belt formed of Acetyl™ links and rollers rotatably mounted in the superstructure. Vehicles approach the car wash, wait in a queue, advance to an entry point, drive onto the conveyor and then leave the car in neutral with foot on the brakes. The conveyor belt moves vehicles through the car wash in assembly line format through a plurality of stations, including a pre-wetting station, a hand-washing station, a rinse station, and a drying station. All the water from the various stations lubricates the links and rollers of the conveyor to create a low-friction continuous wet belt conveyer for low-maintenance and longevity. The wash conveyor extends parallely to an adjacent detail conveyor, and the two conveyors move in opposing directions. Upon completion of the wash, the vehicle moves off the wash conveyor and loops back onto the detail conveyor for interior detailing. A semi-automated system arranged in the foregoing format with dual wash conveyors and dual detail conveyors is capable of 1000+ vehicles per day throughput, and since the entire conveyor path uses a low-friction continuous wet belt conveyer, with specific interlinked belt configuration, infrastructure and materials, there is low-maintenance and longevity despite heavy volume.

### CROSS-REFERENCE TO RELATED APPLICATION(S)

The present application derives priority from U.S. provisional patent application Ser. No. 60/922,756 filed 10 Apr. 2007.

### BACKGROUND OF THE INVENTION

1. Field of the Invention

The present invention relates to car wash systems and, more particularly, to a semi-automated hand wash system based around a continuous fully wet-belt conveyor that provides a turn-key vehicle hand-wash in assembly line format with fully automated spraying and drying stations complemented by an intermediate hand-wash station. The wash conveyor extends parallely to an adjacent detail conveyor, and the two conveyors move in opposing directions. Thus, the fully wet-belt wash conveyor allows a turn-key vehicle hand-wash in assembly line format with fully automated spraying and drying stations complemented by an intermediate hand-wash station. Upon completion the vehicle moves off the wash conveyor and loops back onto the detail conveyor for interior detailing. A semi-automated system arranged in the foregoing format with dual wash conveyors and dual detail conveyors is capable of 1000+ vehicles per day throughput, and since the entire conveyor path uses a low-friction continuous wet belt conveyer, with specific interlinked belt configuration, infrastructure and materials, there is low-maintenance and longevity despite heavy volume.

2. Description of the Background

Despite a high level of automation capability and a wide variety of fully automated cash washes, a hand car wash is still widely considered preferable due to the heightened attention to detail and reduced risk of scratching and damage to vehicles. In acknowledgement of this fact, focus has shifted away from fully-automating the entire wash process toward finding new ways to automate (or expedite) the washing of vehicles by hand.

One approach to the foregoing has been to employ conveyor paths, and there are a variety of vehicle conveyors currently in use. For example, U.S. Pat. No. 3,526,193 issued Sep. 1, 1970 to Vaal shows an early car wash conveyer patent. Unaddressed by the '193 patent are the myriad problems associated with car wash conveyors

For example, it is quite difficult to load a 2-3 ton vehicle onto a continuously moving conveyer belt. United States Patent Application 20060191773 to Horn; Michael E. published Aug. 31, 2006 tackles this problem with a pair of launch conveyors belts feeding full-length drive conveyors. The pair of launch conveyors has zero motion, when a vehicle is driven on and is placed in park, but they accelerate to a speed in synchronous with the pair of drive conveyers.

U.S. Pat. No. 4,967,442 to Weigele issued Nov. 6, 1990 shows an apparatus for washing or drying vehicles with a conveyor belt drawing the vehicle through a multiplicity of narrow strips of absorbent material.

U.S. Pat. No. 4,576,098 to Belanger et al. issued Mar. 18, 1986 shows an automobile conveyor having an endless conveyor chain within a framework with a plurality of roller dollies spaced along the length of the chain. Each roller dolly comes into operative pushing engagement with the vehicle tire.

It is also difficult to track the progress of the vehicle through the wash. U.S. Pat. No. 4,856,543 to Petit issued Aug. 15, 1989 shows a vehicle washing system that tracks the lateral profile of the vehicle by an array of photoelectric cell detectors mounted on a spray bar.

Another major problem stems from the wet and caustic conditions which degrade the belting. Existing vehicle conveyor belts and their infrastructure were meant for dry conditions, and when exposed to water and caustics as in most car washes both the belt and conveyor will corrode and degrade rather quickly over time. While it is possible to minimize this by protecting the belt and infrastructure, this deprives the belt of its most abundant lubricant, the water. It is estimated that water lubrication reduces friction by as much as 75%. It is the intent of the present inventors to provide specifically-adapted fully wet belt system with an array of wet-belt design considerations that provide a turn-key vehicle hand-wash along a specific assembly line format with fully automated spraying and drying stations complemented by an intermediate hand-wash station, all along the path of a low-friction continuous wet belt conveyer, with specific interlinked belt configuration, infrastructure and materials to ensure low-maintenance and longevity.

### SUMMARY OF THE INVENTION

It is therefore an object of the present invention to provide a semi-automated car wash with manual hand-wash station based around a continuous wet-belt conveyor;

It is another object to provide a turn-key vehicle hand-wash in assembly line format with fully automated spraying and drying stations complemented by an intermediate hand-wash station;

It is still another object to provide a low-friction continuous wet belt conveyer to facilitate the foregoing, the belt employing a specific interlinked belt configuration, infrastructure and materials to ensure low-maintenance and longevity.

In accordance with the foregoing and other objects, the present invention provides a hand wash cash wash system for motor vehicles based on a fully-wet belt conveyor through a plurality of stations including a manual hand-wash station. The conveyor is adapted for continuous operation in a wet environment and indeed relies on the water from the wash stations for lubrication. The adaptations for wet-belt design include a concrete foundation formed with a recessed drainage pit for runoff. A superstructure is seated atop the foundation and this comprises a framework of galvanized steel legs and struts. The continuous conveyor is mounted on the superstructure further comprises a conveyor belt formed of Acetyl™ links and rollers rotatably mounted in the superstructure. Vehicles approach the car wash, wait in a queue, advance to an entry point, drive onto the conveyor and then leave the car in neutral with foot on the brakes. The conveyor belt moves vehicles through the car wash in assembly line format through a plurality of stations, including a pre-wetting station, a hand-washing station, a rinse station, and a drying station. All the water from the various stations lubricates the links and rollers of the conveyor to create a low-friction continuous wet belt conveyer for low-maintenance and longevity.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of one of the lanes of the dual-lane vehicle hand-wash system 2 in accordance with the present invention, viewed from the exit end.

FIG. 2 is a front view of the entry port 20.

FIG. 3 is a close-up view of an exemplary centering pinion 220.

FIG. 4 is a front view of the entry port 20 which better shows the transition/undercarriage spray plate 240 with inset at right.

FIG. 5 is a perspective illustration of the foundation and superstructure for the belts 100 and surrounding building.

FIGS. 6 and 7 are perspective illustrations detailing the belts 100 and rollers 122 supported on galvanized steel superstructures 130 seated on the cement foundation.

FIG. 8 is a perspective view of the electronic eyeposts encountered prior to the washing stations.

FIG. 9 is a perspective view of an exemplary pair of wheel cleaner spray applicators 300, one pair directed inward from each side of conveyor belt 100.

FIG. 10 is a perspective view of the support carriage 400.

FIG. 11 is a perspective view of the hand-washing station 40.

FIG. 12 illustrates the rinse station 50 inclusive of overhead arch 550 bearing an array of clean-water rinse nozzles and a bottom-mounted pair of rotating wheel rinse jets 560.

FIG. 13 illustrates the drying station 60 inclusive of high-air-flow dryers 610.

FIG. 14 shows the motors 700 for driving the conveyor belts 100.

FIG. 15 is a close-up illustration of a motor 700 with flanking deck floor panel removed to reveal the transverse drive shaft 730.

FIG. 16 illustrates the chemical dispensary by which the various cleaners, solvents and waxes are dispensed to the pre-wetting station 40.

FIG. 17 illustrates the input booster pump 900.

### DETAILED DESCRIPTION OF THE PREFERRED EMBODIMENTS

The present invention is a vehicle hand-wash system incorporating a self-lubricating full-length wetted belt conveyer with an array of welt-belt design considerations that facilitates a more efficient hand-wash in an assembly line format with fully automated spraying and drying stations, all complemented by an intermediate hand-wash station. The water from the wash process lubricates the continuous wet belt conveyor and maintains the interlinked belt configuration and rollers in a low-friction state to ensure low-maintenance and longevity. The invention is herein described in the context of a dual-lane vehicle hand-wash facility for increased throughput, though a single lane is also contemplated.

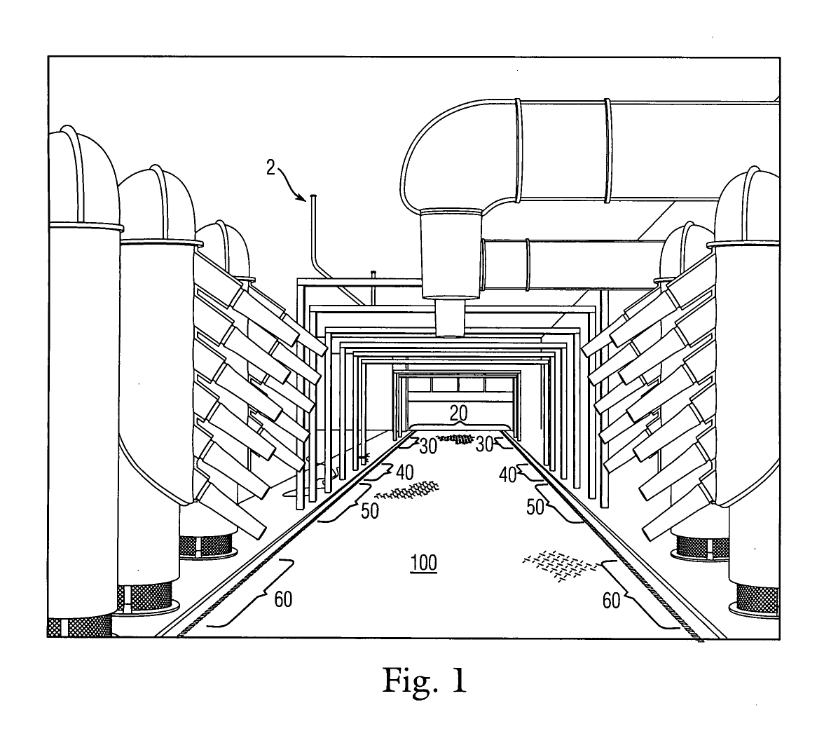

FIG. 1 is a perspective view of one of the lanes of the dual-lane vehicle hand-wash system 2 in accordance with the present invention, viewed from the exit end. Each lane of the dual-lane vehicle hand-wash system 2 is based around a continuous conveyer belt 100 that conveys each incoming vehicle past a plurality of stations, including a pre-entry vehicle queue 10 (obscured), entry port 20, pre-wetting station 30, hand-washing station 40, rinse station 50, and drying station 60. The continuous conveyer belt 100 is recessed within a superstructure (to be explained) that is seated atop a concrete foundation and is fully enclosed within a heated and ventilated building for year-round operation. Once aligned and checked in at the pre-entry vehicle queue 10, each vehicle is driven onto the continuous belt 100 at the entry port 20 and is placed in neutral with brakes applied. The belt 100 takes the vehicle through the pre-wetting station 30 which applies an underwash, presoaks the vehicle, and applies soap chemical. The vehicle is then run through a hand-washing station 40 wherein a group of workers manually scrub the car using washing tools maintained in a self-rinsing bin. Following the hand wash the vehicle continues through the rinse station 50 where it is sprayed with filtered water for rinsing, and then through a high-capacity drying station 60 before it exits the wash. If desired, the hand wash system 2 may be followed by an interior detail system comprising another identical continuous conveyor 100 that runs through a manual detailing station. In this case, each lane of the hand wash system 2 may be matched to an adjacent corresponding lane of the hand detailing system through the same building such that the vehicle travels an out-and-back pattern, with wash going out and detail coming back.

The vehicle queue 10 is a pre-entry vehicle checkpoint for prescreening vehicles, registering the vehicle at a point-of-sale terminal and ordering options (such as wax application of RainX™). The vehicle queue 10 is simply a stop point indicated by a painted lines or a gate at which vehicles are stopped prior to entry to allow an employee to enter driver and vehicle information into a point of sale (POS) system. The present system incorporates a point of sale (POS) system with wireless point-of-sale terminals for ease of data entry at the queue 10, and these are available from DRV or Wincor Nixdorf, Inc. Preferably, the vehicle queue 10 also includes a freestanding or suspended vehicle height-check bar to ensure that entering vehicles are not too tall for the wash. When check-in is completed the employee will instruct the driver to continue to the entry port 20.

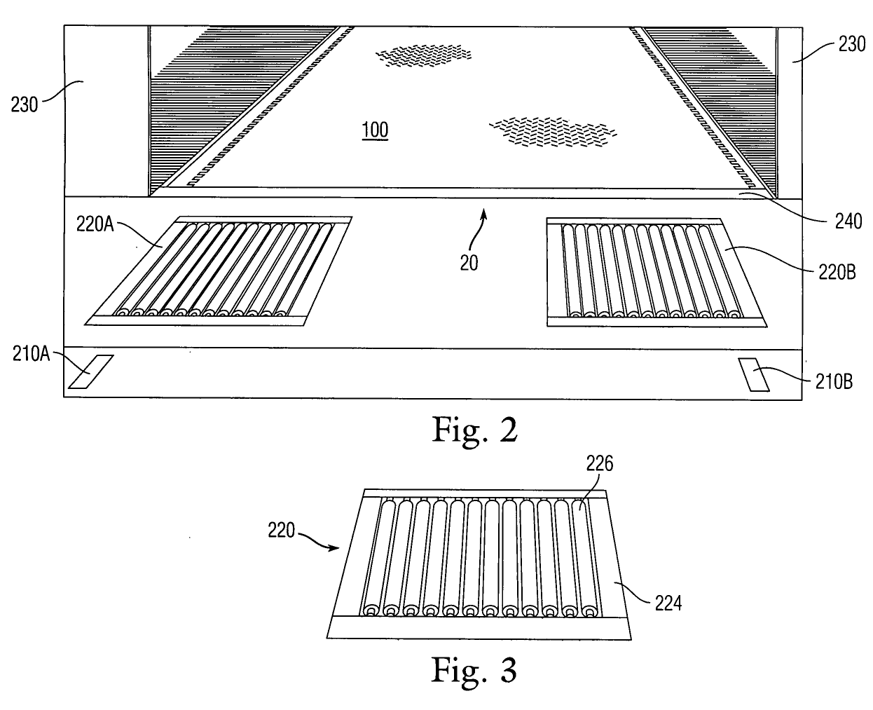

FIG. 2 is a front view of the entry port 20 which generally includes a pair of visual vehicle alignment lines 210A & 210B, optional centering pinions 220A & 220B, the actual opening into the building bay flanked by removable door jambs 230 (for easy replacement), and a combination transition/undercarriage spray plate 240. In addition, there is signage at the entry port to instruct drivers to “place foot on brake and put car in neutral”, and video cameras (obscured) to record each entry.

The visual vehicle alignment lines 210A & 210B are opposing parallel lines painted onto the pavement at approximately tire-width to guide vehicles onto the centering pinions 220A & 220B and subsequently the belt 100.

The centering pinions 220A & 220B are designed to align the vehicle perfectly parallel to the belt 100 and do this by allowing the rear wheels of the vehicle to shift back-or-forth after the front wheels are planted on the belt 100.

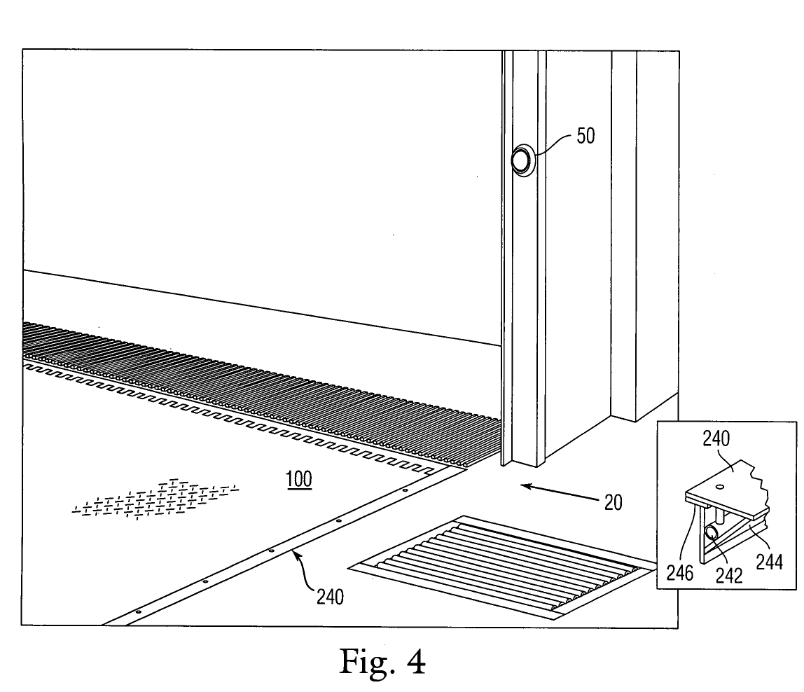

FIG. 3 is a close-up view of an exemplary centering pinion 220 which comprises a rectangular galvanized steel frame 224 recessed into the pavement and pivotally supporting a series of parallely-arranged rollers 226. If two centering pinions 220 are implemented at tire-width in advance of the belt 100 they will allow off-kilter vehicles to self-align as described. However, it has been found that the visual vehicle alignment lines 210A & 210B are sufficient for this purpose and so the centering pinions 220 are optional.

The actual door frame opening into the building bay is flanked by removable rubber door jambs 230. At the rate of a thousand vehicles per day it is not uncommon for drivers to bump the edges and these removable door jambs 230 can be easily replaced.

A very salient improvement comprises a combination transition/undercarriage spray plate 240. This eliminates the need for launch conveyor(s) to accelerate the vehicle to a speed in synchronous with the continuous belt conveyer as specified in the prior art. It also serves as a the undercarriage spray nozzle for jetting water directly up against the undercarriage of the vehicle as it enters the bay.

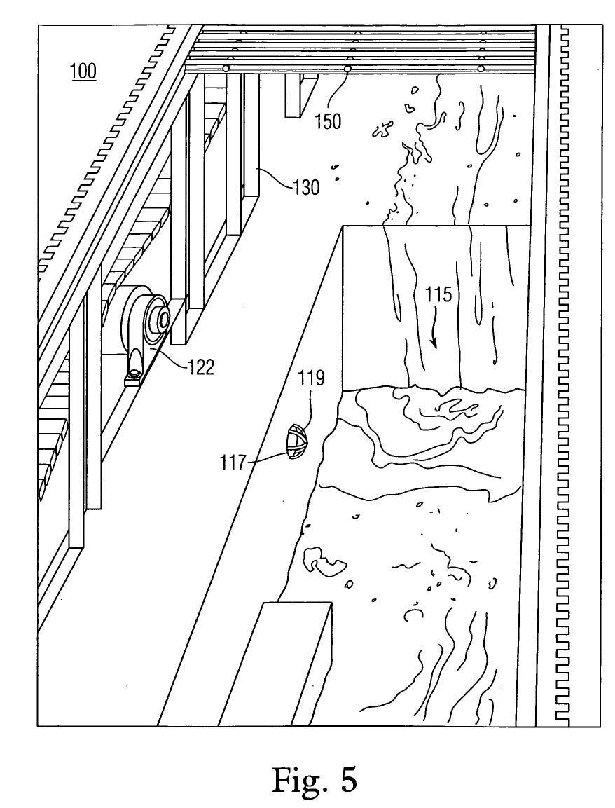

FIG. 4 is a front view of the entry port 20 which better shows the transition/undercarriage spray plate 240 with inset at right. The transition/undercarriage spray plate 240 further comprises a 144¾″ long by 16″ wide panel of ⅜″ galvanized steel plate plasma-drilled with spray orifices along its major length at approximately 8″ intervals. The transition/undercarriage spray plate 240 is supported on a diagonal mounting strut 242 welded thereto on the underside and attached to the superstructure supporting the conveyor belt 100 (to be described). The diagonal strut 242 positions the inner edge of the transition/undercarriage spray plate 240 approximately ½″ from the conveyor belt 100. An angle bracket 244 is attached as shown lengthwise beneath the transition/undercarriage spray plate 240 to support the weight of vehicles moving onto the belt. A pressurized water pipe 246 runs lengthwise under the transition/undercarriage spray plate 240 behind the angle bracket 244 and this communicates with the spray orifices. Thus, as each vehicle enters the bay the spray nozzles are activated to jet water directly up against the vehicle undercarriage for cleaning. Moreover, the close proximity of the edge of the transition/undercarriage spray plate 240 to the conveyor 100 allows a vehicle to be driven directly onto the conveyor 100 without need of any launch conveyor(s) to accelerate the vehicle up to the conveyor speed. They simply drive the front wheels onto the conveyor 100. Signage at this point hanging directly in front instructs the drivers to “place foot on brake and put car in neutral.” Thus, with the front wheels locked, the vehicle is dragged onto the conveyor 100.

Also shown in FIG. 4 is one of two side mounted video cameras 50 installed on the opposing sides of the door frame leading into the bay. These video cameras 50 record a video of each vehicle (from both sides) as it enters the bay to refute or confirm any damage claims.

At this point the vehicle begins its traverse along the continuous conveyor belt 100. The conveyor belt 100 is a continuous polymer-link belt that stretches approximately 90 feet through the bay. The belt 100 is seated on a plurality of rollers supported on an underlying superstructure as will be described. The belt 100 itself is preferably an Intralox™ belt formed of Actyl plastic links in a modular and hinged configuration such as the series 400 acetyl belt distributed by Intralox, Inc. of Harahan, La., a division of The Laitram Corporation.

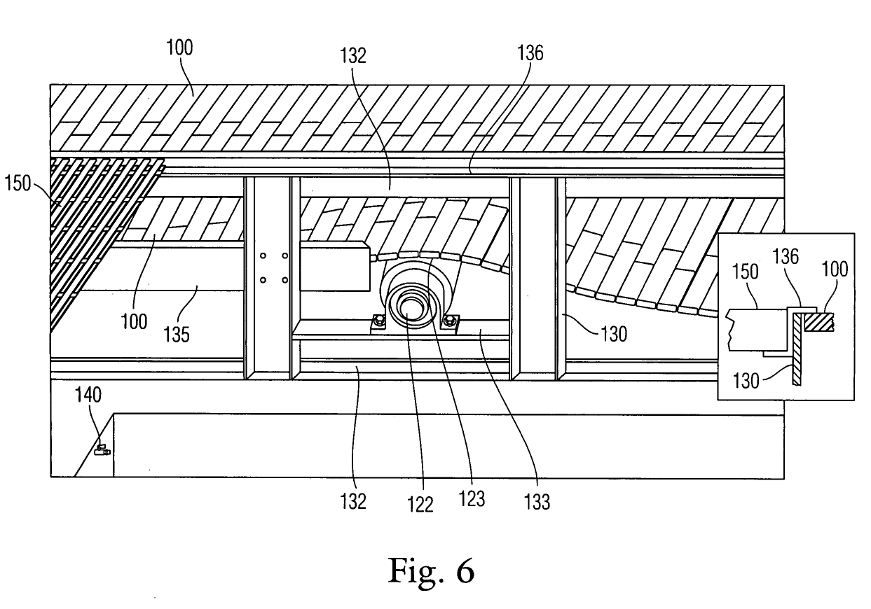

FIG. 5 is a perspective illustration of the foundation and superstructure for the belts 100 and surrounding building. The foundation and superstructure sit atop a substantially flat concrete foundation recessed below floor level and formed with at least a 1000 gallon drainage pit 115. In the illustrated dual-lane configuration the drainage pit 115 is situated between the lanes and comprises a large rectangular recess with outlet pipes 117 leading outside to exterior recycle tanks. Each outlet pipe 117 is capped by a dome-shaped grate 119 to prevent large refuse from clogging the pipes. The drainage pit 115 and pipes 117 make it possible to contain and, if necessary, recycle the runoff when both of the lanes are emitting 50 gallon/minute in wash.

The belts 100 and rollers 122 are supported on galvanized steel superstructures 130 that raise the belts 100 off the cement foundation. A floor space is formed by free-floating aluminum-plastic deck panels 150 installed on flanking sides of each belt 100 at belt-level. There should be at least eight feet of space on each side of each lane and in the middle to provide ample space for the cleaning stations as will be described, and panels 150 provide this floor space. The deck panels 150 each comprise evenly spaced parallel lengths of 1″ square PVC tubing bound together by stainless steel rods, and cut into appropriately-sized panels as needed. This type of decking ensures that water will drain directly through to the collection tank.

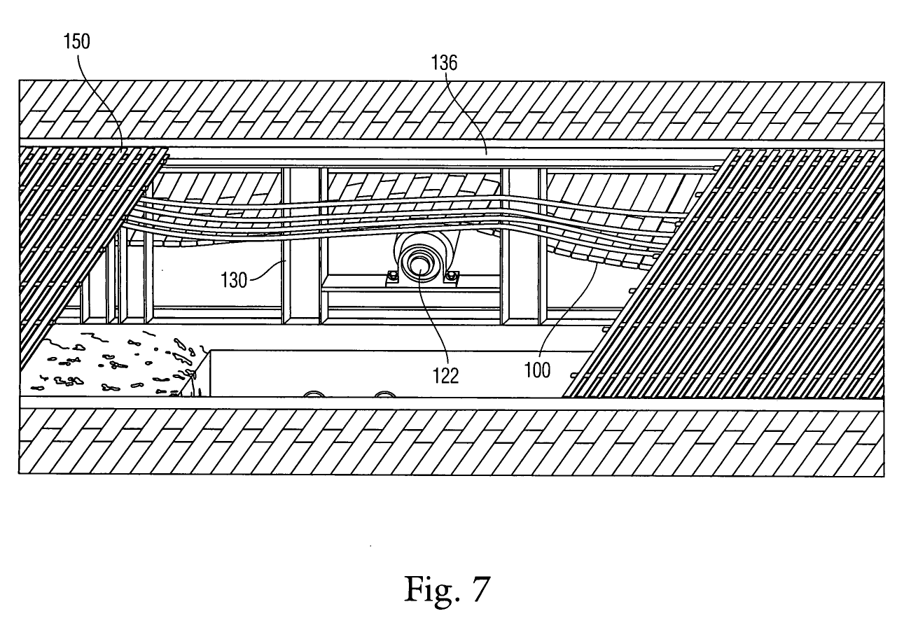

FIGS. 6 and 7 are perspective illustrations detailing the belts 100 and rollers 122 supported on galvanized steel superstructures 130 seated on the cement foundation. The superstructures 130 comprises galvanized steel beams formed as legs on both sides of each bay, and elongate top and bottom struts 132 formed in a rectangular framework for additional support and mounting capabilities. The legs and struts 132 are bolted together. Occasional raised support struts 133 are suspended at appropriate heights at intervals along the superstructure 130 to support the rollers 122 for tensioning the belts 100. Currently six rollers 122 are used for each belt 100, and the lower return of belts 100 ride overtop the rollers 122. The rollers 122 are suspended at an appropriate height as necessary to tension the upper portion of the belts 100 at a level even with the deck panels 150. Typically, it will be necessary to level the belt 100 along its 100 foot length, and this is done by surveying the belt 100 and, if necessary, placing shims between the legs of superstructure 130 and the concrete foundation to level it.

The rollers 122 do not of themselves maintain the belt 100 centered thereon and a creeping belt 100 can do significant damage to itself resulting in costly repairs and downtime. To avoid this an important aspect of the present invention is a series of equally-spaced belt centering guide shoes 135 oriented lengthwise alongside the returns of the belts 100 proximate the rollers 122. Each belt centering guide shoe 135 may be an elongate block of stainless steel anchored inside the superstructure as shown in FIG. 6 to leave approximately a ½″ spacing between the adjacent belt 100. Here six belt centering guide shoes 135 are spaced along each belt 100 in three opposing pairs, and these serve well to keep the belts 100 centered on the rollers 120.

Both sides of the superstructures (on opposing sides of the belts 100) are equipped with stainless steel angle brackets 136 running the length of the superstructures 130. The angle brackets 136 are formed with double-angles as seen in the inset of FIG. 6, the vertical central section being riveted to the superstructures 130 using stainless steel rivets so as to avoid corrosion. These angle brackets 136 serve a dual purpose: 1) to provide a seating for the flooring deck panels 150, which fill the space between the belts 100; and 2) to overlay the edges of the belts and afford protection against shoelaces, fingers or toes getting dragged into the belts 100, as well to protect the edges of the belts 100 from errant tires.

The rollers 122 are 8′ sealed-grease-bushing rollers 8″ diameter cylindrical rollers suited for a 20,000 pound load and held captive by mounting yokes bolted to superstructure 130. While such rollers are commercially available, there are two important design considerations in the present context. First, since commercial rollers have stainless steel bodies (are not meant for wet use), the entire length of each roller 122 is coated with a PVC coating to reduce corrosion (see FIG. 6). Second, all grease fittings (nipples) for grease-gun lubrication of the rollers 122 are extended by tubing out to the inside of the superstructure 130 (to the center aisle in the dual lane embodiment). This results in remotely accessible compression grease fittings 140 for the entire lengths of each roller 122, without which holes must be drilled through the conveyor belts 100 to reach the existing OEM grease fittings.

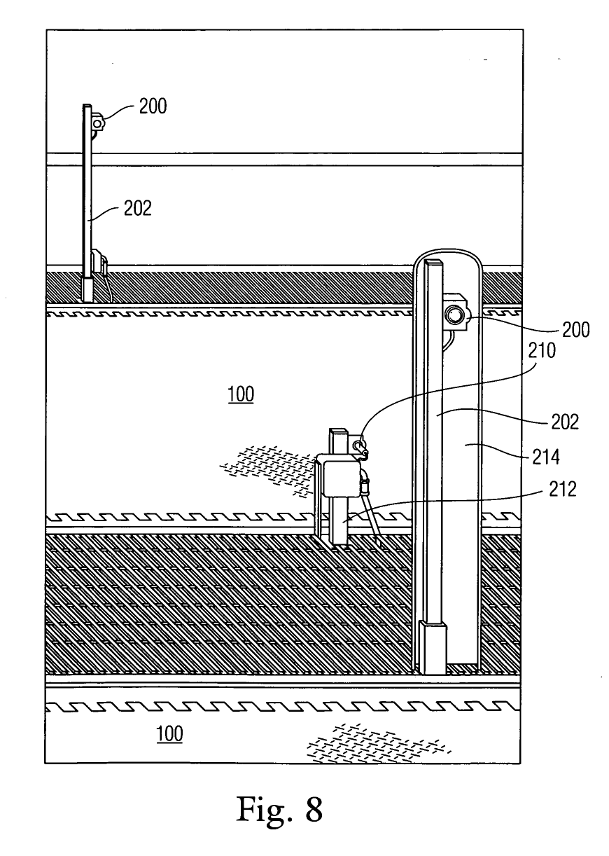

FIG. 8 is a perspective view of the electronic eyeposts encountered prior to the washing stations. The electronic eyeposts comprise an infrared transmitter 200 and infrared receiver 210 both mounted at approximately bumper-height on aluminum mounting posts 202, 212 on opposing sides of each conveyor belt 100. The infrared transmitter 200 emits a beam to infrared receiver 210 that is broken when a vehicle passes, thereby creating a trigger signal to initiate the washing equipment (to be described). Note that in the dual-lane context a deflector plate 214 must be mounted on post 212 behind each receiver 210 to prevent the beam from one lane from reaching the other.

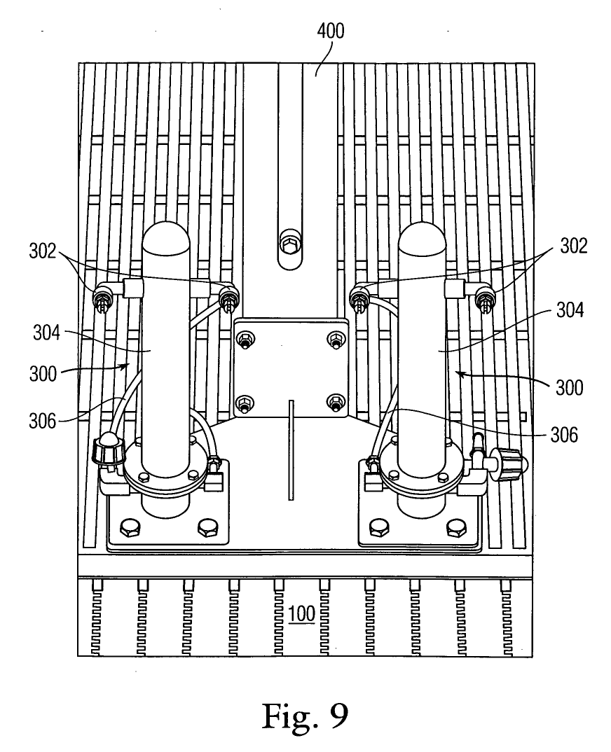

With the washing equipment enabled, the vehicle will enter the pre-wetting station 30 (FIG. 1) and encounter opposing pairs of wheel cleaner spray applicators 300 as shown in FIG. 9, one pair on each side of conveyor belt 100. Each individual wheel cleaner spray applicator 300 further comprises a pair of spray nozzles 302 mounted on posts 304 and directed toward the vehicle wheels. The spray nozzles 302 are in fluid communication with a pressurized reservoir of wheel cleaning solution via plastic tubing 306. The spray nozzles 302 are U-bolted as shown to a support carriage 400 that supports overhead pre-wetting equipment

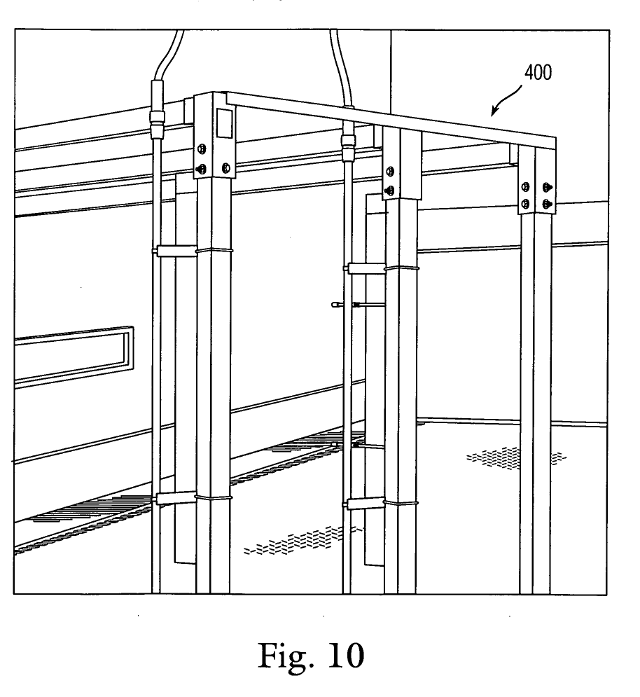

FIG. 10 is a perspective view of the support carriage 400 which comprises an aluminum six-legged post-and beam framework that overarches the conveyer belt 100 and the vehicles passing beneath. Prewetting nozzles mounted up and down the initial two legs and overhead beams spray water onto the vehicles, while the third legs/beam are equipped with spray nozzles for spraying wash solution. The prewetting and wash spray nozzles and conduits are commercially available equipment supplied by a variety of car wash equipment manufacturers. Note that all of the water and cleaning solution emitted from the wheel cleaner spray nozzles 302, and prewetting nozzles on support carriage 400 fall directly onto the conveyor belt 100 and serve to lubricate it.

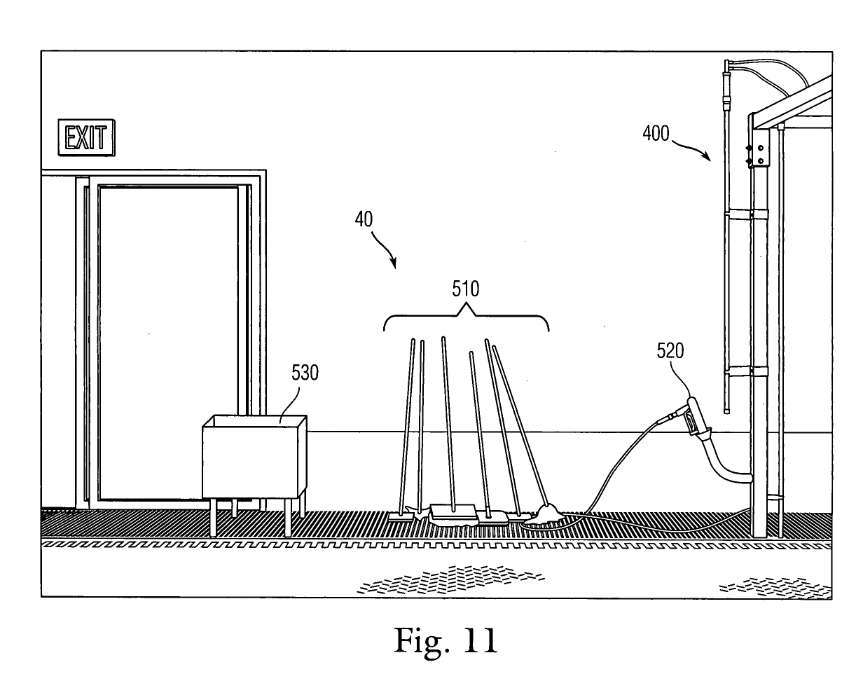

With each vehicle properly pre-wetted with water and cleaning solution, the vehicles enter a hand-washing station 40 as shown in FIG. 11. Employees have approximately 45 seconds as each vehicle travels past to hand-scrub the vehicle, and this is facilitated by an array of hand-washing implements 510 such as scrub brushes and mops, a high-pressure spray gun 520, and a stainless sink 530. Dirty implements 510 may be rinsed in the sink 530. The sink 530 is connected by input and output hoses so that clean water can be circulated in and dirty water drained out, and it important to install a mesh grate a few inches above the bottom of the sink 530 to allow particulates to settle to the bottom. Otherwise these might scratch the vehicles. The foregoing array of implements 510, spray gun 520 and sink 530 enable a typical crew of four employees (two per side) to fully scrub each vehicle within the 45 second window.

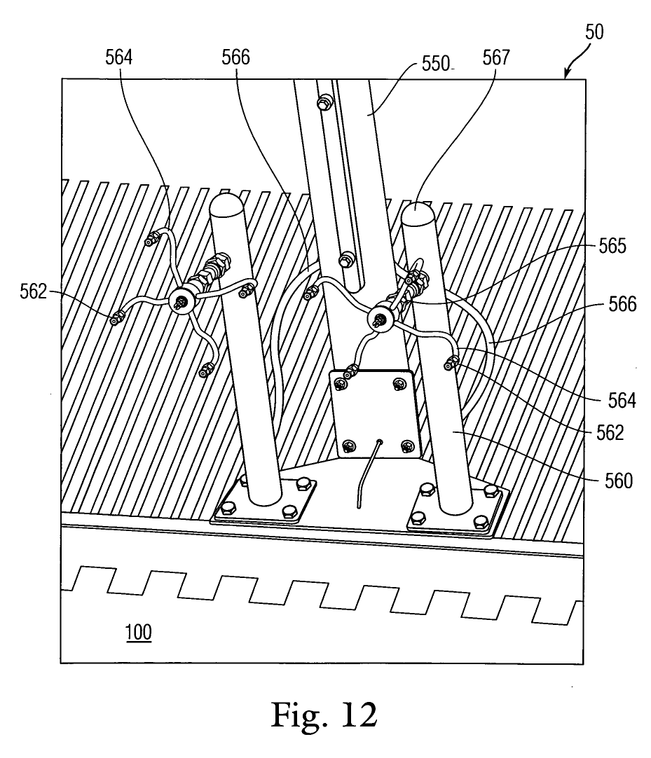

The vehicle next travels through a rinse station 50 which, as seen in FIG. 12 comprises an overhead arch 550 bearing an array of clean-water rinse nozzles (obscured) and, at the bottom, an opposing pair of rotating wheel rinse jets 560, one pair on each side of conveyor belt 100. Each individual wheel rinse jet 560 further comprises an axial array of high-pressure spray nozzles 562 mounted on rigid hoses 564, which are in turn connected to a rotating conduit 565 mounted on a raised post 567, the nozzles 562 being directed toward the vehicle wheels. The rotating wheel rinse jets 560 are also in fluid communication with a pressurized water supply via plastic tubing 566. The wheel rinse jets 560 are bolted as shown to the arch 550 and to the superstructure through the floor deck panels. The clean-water rinse and rotating wheel rinse jets 560 fully rinse each vehicle, and all water falls directly onto the conveyor belt 100 and serves to lubricate it.

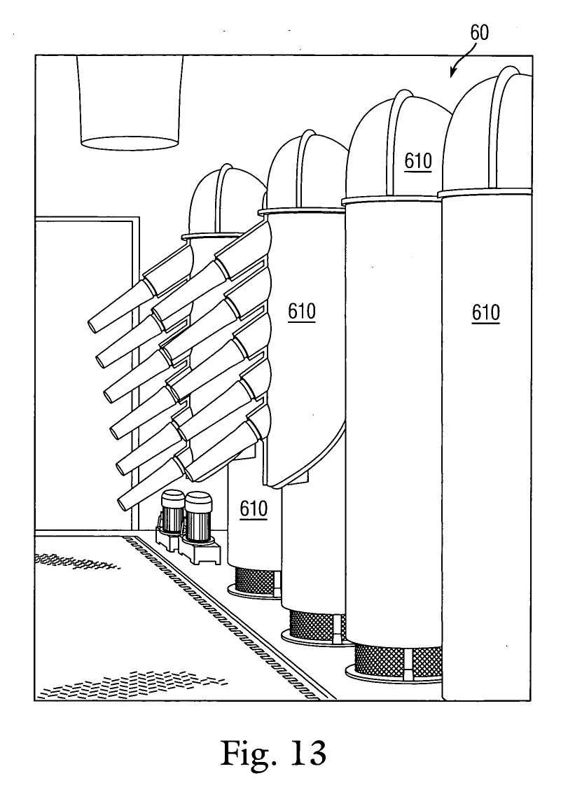

Finally, as shown in FIG. 13, the vehicle emerges from the rinse station 50 and enters a drying station 60 comprising an array of high-air-flow dryers 610 directed sideward toward the vehicle (from both sides) and from overhead. The dryers 610 may be commercially-available car-wash dryers bolted as shown to the underlying superstructure through the floor deck panels.

The vehicle then leaves the conveyor belt 100 from an exit transition plate similar to the transition/undercarriage spray plate 240 described above but without spray jets.

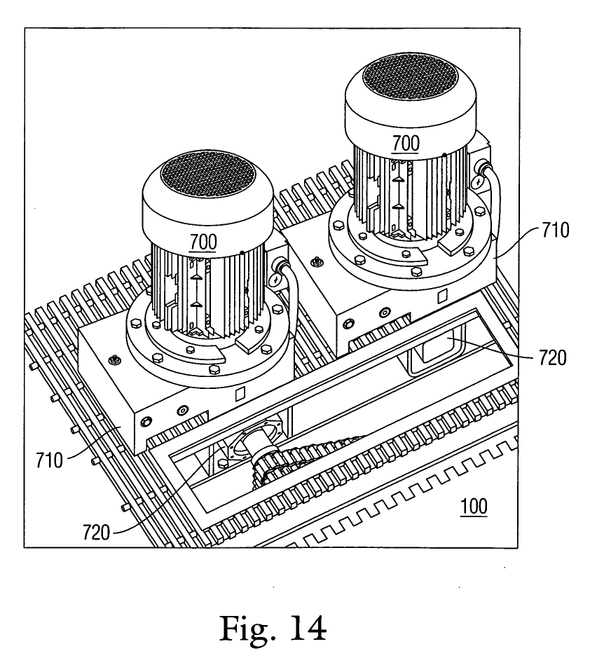

As seen in FIG. 14, each conveyor belt 100 is powered from a 480V AC 11 kW 67552 lbs/in Nord™ motor 700 capable of 1765 rpms, and driving a 122.46 ratio SK160VH/4 gear reducer to attain a top speed of 14 mph on the conveyor. Motor 700 is mounted vertically on a mounting block 710 to raise it above the belt 100 to avoid water contact. The vertical mounting conserves space. The motors 700 are adjustable speed and are equipped with extended rotors protruding down to a gear reduction drive 720 with transverse drive shaft driving a sprocket engaged to the conveyor belt 100. In the context of the illustrated dual-lane car wash two motors 700 are best mounted front-and-back between the lateral conveyor belts 100, the respective drive shafts of the gear reduction drives 720 protruding laterally offset from each other. The length of one belt 100 is extended slightly beyond the other so that the offset drive shafts of the gear reduction drives 720 can engage at different points.

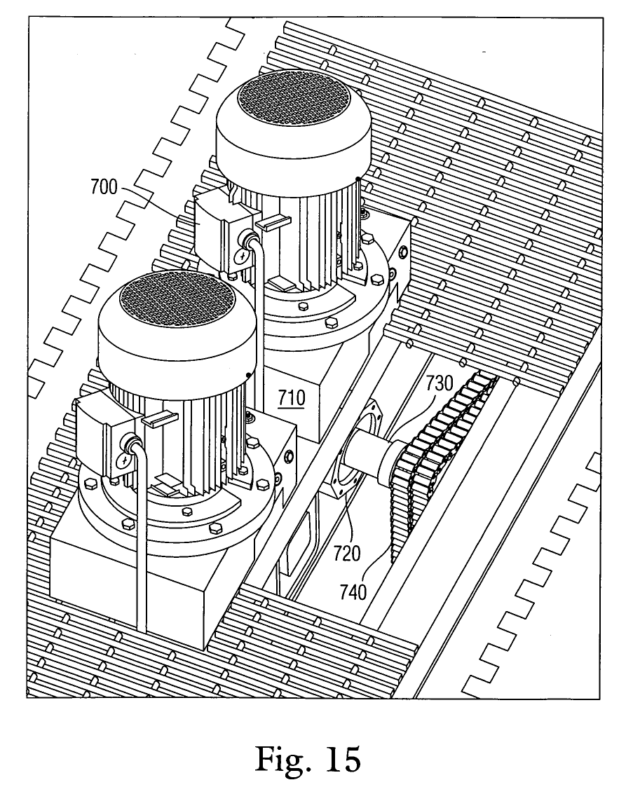

FIG. 15 is a close-up illustration of a motor 700 with flanking deck floor panel removed to reveal the transverse drive shaft 730 extending laterally to the sprocket 740 engagement with the belt 100. The motor 700 and reduction gears 720 are each capable of conveying upward of fifteen tons of gross vehicle weight (4-6 vehicles) at anywhere from 0-3 mph along the conveyor.

While not explicitly shown, it is suggested that full bay-length thermal heaters be mounted along both bays proximate the rooftop to warm employees and maintain productivity during cold winter months.

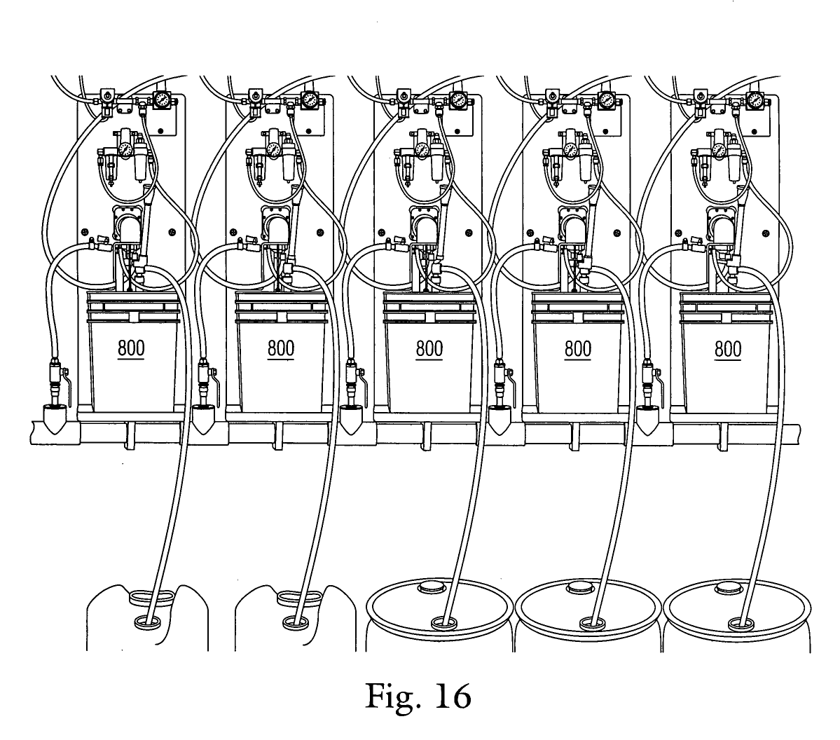

FIG. 16 illustrates the chemical dispensary by which the various cleaners, solvents and waxes are dispensed to the pre-wetting station 40. Each chemical is siphoned out of its drum to a holding tank 800 before being pumped out to its respective nozzle bank at the pre-wetting station 40. Given the caustic nature of these chemicals an eyewash station should be maintained in proximity to meet OSHA requirements.

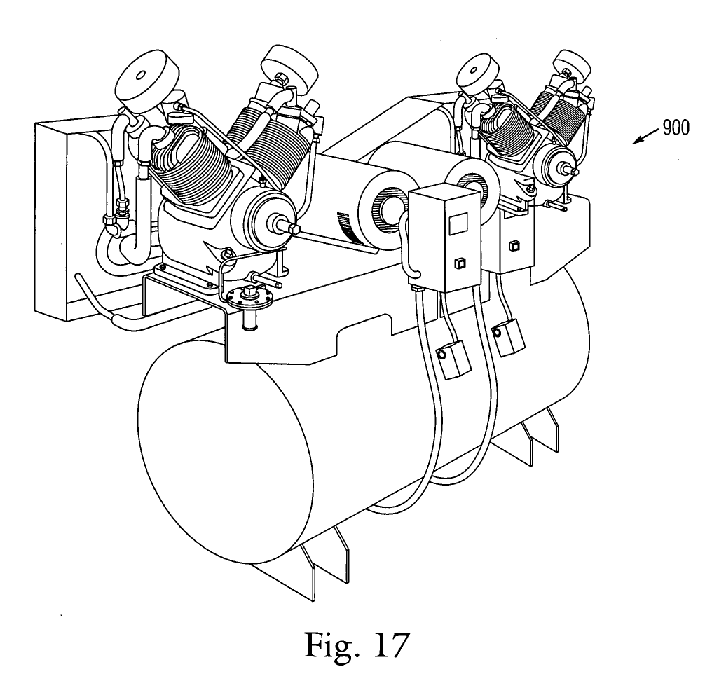

The water pumping equipment, water filters and water heaters for the various pressurized spray nozzles should be situated in a separate equipment room. An input pump is required to pump water from a standard 2 inch water main, and for this purpose a variable drive booster pump is recommended. FIG. 17 illustrates the input booster pump 900 which is a Telemechanik four-piston pump to meet a variable demand of as much as 50 gals/min. The main supply of water must then be filtered, heated and pumped to the various spray equipment. Hot water is preferred because it cleans the vehicles more effectively (removing heavy dirt and salt) and causes the cleaning/waxing chemicals to work better as well. While various commercial equipment may suffice for this purpose, the dual bay high-throughput carwash of the present invention necessitates very robust equipment, and five stacked pumping stations each capable of 40 gals/min such as ABW model ps2h5 mounted on vibration damping pins may be used. The water is fed through 2″ conduits through filter banks (here U.S Filter™) and is heated by a Power Fin by Lockinbar 2,000,000 btu water heater before being dispensed to the various spray outlets. Note that all floor-mounted pumping equipment should be mounted on floating vibration-damping pins journaled into the concrete foundation to minimize noise and vibration damage to the equipment.

A separate glass-enclosed control room may be furnished to monitor all aspects of the foregoing carwash, and all sensors, pumps and motors may be centrally connected to a central PLC controller in the control room for centralized operation.

One or more of the above-described wash conveyors 100 may be run through an enclosure with doors at both ends, though multiples of two is preferred so that the majority of hand-washing equipment can be placed centrally there between.

The wash conveyors 100 extend parallely to one or more adjacent detail conveyors, the two types of conveyors moving in opposing directions. Thus, the fully wet-belt wash conveyor allows a turn-key vehicle hand-wash in assembly line format with fully automated spraying and drying stations complemented by an intermediate hand-wash station. Upon completion the vehicle moves off the wash conveyor and loops back onto the detail conveyor for interior detailing. Note that since the above-described spray-wash equipment is not necessary on the detail side is preferred to employ water jets to keep the detail side wet.

A semi-automated system arranged in the foregoing format with dual wash conveyors/lanes and dual detail conveyors/lanes is capable of 1000+ vehicles per day throughput, and since the entire conveyor path uses a low-friction continuous wet belt conveyer, with specific interlinked belt configuration, infrastructure and materials, there is low-maintenance and longevity despite heavy volume.

It should now be apparent that the above-described semi-automated yet hand-wash system inclusive of the pre-entry vehicle queue 10, entry port 20, pre-wetting station 30, hand-washing station 40, rinse station 50, and drying station 60 facilitates a more efficient hand-wash in an assembly line format capable of upward of 1000 vehicles per day throughput. Even so, the continuous belt conveyors with interlinked belt configuration and rollers are freely lubricated by the spray water to keep a low-friction state, and the all-stainless/aluminum/galvanized/polymer construction ensures low-maintenance and longevity for an estimated 10-20 year lifetime of the car wash. This effectively quadruples the normal 2-5 year lifetime of conventional car washes which are inevitably and unsuccessfully built to maintain a dry conveyor, but fail and corrode.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

We claim:

1. A cash wash system for vehicles, comprising:
a concrete foundation formed with a recessed drainage pit;
a superstructure seated atop said foundation and comprising a framework of galvanized steel legs and struts;
a continuous conveyor mounted on said superstructure, said conveyor comprising a conveyor belt formed of Acetyl™ links and rollers rotatably mounted in said superstructure; said conveyor belt moving vehicles through the car wash in assembly line format through a plurality of stations, including;
a pre-wetting station,
a hand-washing station,
a rinse station, and
a drying station; wherein the water from said pre-wetting station, hand washing station and rinse stations lubricates the links and rollers of said conveyor to create a low-friction continuous wet belt conveyer for low-maintenance and longevity.

2. A cash wash system for vehicles, comprising:
a first continuous wet-belt conveyor rotating in one direction for moving vehicles through successive spray, pre-soap and hand-wash stations, wherein water and soap from said stations maintains said continuous wet-belt conveyor fully lubricated;
a second continuous wet-belt conveyor arranged parallely adjacent to said wet-belt conveyor and rotating opposite to said one direction for moving vehicles through an interior detailing station.
